(19) United States
(12) Patent Application Publication
(10) Pub. No.: US 2018/0204173 A1
(43) Pub. Date: Jul. 19, 2018

(54) Data Processing System and Method for Rules/Machine Learning Model-Based Screening of Inventory

(71) Applicant: FAIR IP, LLC, Santa Monica, CA (US)

(72) Inventors: Scott Edward Painter, Los Angeles, CA (US); Craig Michael Nehamen, Sherman Oaks, CA (US); Mason Grey McLead, Redondo Beach, CA (US); Matthew Donovan Cragin, Los Angeles, CA (US)

(21) Appl. No.: 15/873,498

(22) Filed: Jan. 17, 2018

Related U.S. Application Data
(60) Provisional application No. 62/447,362, filed on Jan. 17, 2017.
(60) Provisional application No. 62/447,349, filed on Jan. 17, 2017.
(60) Provisional application No. 62/596,007, filed on Dec. 7, 2017.

(51) Int. Cl. G06Q 10/08; G06N 5/02; G06N 99/00; G06Q 40/00

(52) U.S. Cl. CPC G06Q 10/087; G06N 5/025; G06Q 40/10; G06Q 40/12; G06N 99/005

(57) ABSTRACT

One embodiment comprises a rules-based data processing system comprising a data store storing a set of machine learning model-based depreciation models, each depreciation model having an associated vehicle year/make/model/trim, and payment rules to determine payment schedules for vehicles using the set of depreciation curves. The rules-based data processing system can further comprise a processor and a memory coupled to the processor storing a set of computer executable instructions. The set of computer executable instructions executable to receive a first set of inventory feed records, each inventory feed record in the first set of inventory feed records comprising a vehicle identification number (VIN), dealer price and mileage and apply a first set of filter rules to the first set of inventory feed records to identify a second set of inventory feed records corresponding to vehicles having year/make/model/trim for which a depreciation curve is stored in the data store.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### RELATED APPLICATIONS

This application claims priority under 35 U.S.C. § 119(e) to U.S. Provisional Application No. 62/447,362, entitled “Networked Data System and Method for Filtering Electronic Records,” filed Jan. 17, 2017, U.S. Provisional Application No. 62/596,007, entitled “Data Processing System and Method for Managing Location Independent Transactions,” filed Dec. 7, 2017 and U.S. Provisional Application No. 62/447,349, entitled “Networked Vehicle Data System,” filed Jan. 17, 2017, each of which is fully incorporated herein by reference for all purposes.

### TECHNICAL FIELD

The present disclosure relates generally to the field of data processing systems and methods. More particularly, some embodiments relate to data processing systems and methods for rules/machine learning model-based filtering of electronic records.

### BACKGROUND

Internet-based systems and other computer systems that facilitate purchasing (buying or leasing) various goods and services from multiple sellers have become increasingly popular tools for both consumers and sellers. Using the example of vehicle sales, a number of intermediary search sites allow users to search for vehicles from a large number of vehicles. When a user selects a vehicle, the intermediary site typically puts the buyer in touch with the dealer to finalize the transaction. The consumer may schedule a test drive with the dealership and, if the consumer chooses to purchase the vehicle, negotiate a price with the dealer. In some cases, technology may facilitate the negotiation by providing indications of market prices. This can give the consumer confidence walking into the dealership, but serves largely as a negotiation tool. The final negotiated price still relies on back and forth negotiation until, optimally, both the consumer and dealer reach the subjective belief that they came to a fair deal.

An intermediary vehicle search site, however, may have very little control over the quality of data provided by dealers, including the quality of pricing data. This can lead to the inefficient use of resources at the intermediary site. For example, the dealer may leave out important information, such as the color of the vehicle or other information, when providing data about the vehicle to the intermediary search site. As another example, the dealer may inadvertently price a vehicle at a price point that is so high that few, if any, consumers will be interested in the vehicle. Yet, the vehicle associated with the poor quality or incomplete data may still show up in search results. In addition, some buyers may select to view the vehicle even if they would not buy the vehicle. From the perspective of the intermediary site, the data for a vehicle that is poorly priced or otherwise unlikely to be sold represents wasted storage space and the processing resources used to search for and return the vehicle information to buyers (e.g., in response to search queries or requests to the view the vehicle) are wasted processing resources.

### SUMMARY

One embodiment comprises a rules-based data processing system comprising a data store storing a set of depreciation models, each depreciation model having an associated vehicle year/make/model/trim, and payment rules to determine payment schedules for vehicles using the set of depreciation curves. The rules-based data processing system can further comprise a processor and a memory coupled to the processor storing a set of computer executable instructions. The set of computer executable instructions executable to receive a first set of inventory feed records, each inventory feed record in the first set of inventory feed records comprising a vehicle identification number (VIN), dealer price and mileage and apply a first set of filter rules to the first set of inventory feed records to identify a second set of inventory feed records corresponding to vehicles having year/make/model/trim for which a depreciation curve is stored in the data store.

Filtering the first set of inventory records to identify the second set of inventory feed records can include, determining for each vehicle in the first set of inventory feed records, if there is a corresponding depreciation curve for the year/make/model/trim of the vehicle in the set of depreciation curves. Based on a determination that there is not a corresponding depreciation curve for the year/make/model/trim of the vehicle in the set of depreciation curves, filtering out the inventory feed record for that vehicle. Based on a determination that there is the corresponding depreciation curve for the year/make/model/trim of the vehicle in the set of depreciation curves, include the inventory feed record for that vehicle in the second set of inventory feed records;

For each vehicle in a program pool that comprises vehicles from the second set of inventory records, the system can apply the payment rules using the depreciation curve corresponding to the year/make/model/trim of the vehicle to determine a payment schedule for one or more vehicles in the second set of inventory records and storing the payment schedule for the vehicle in an inventory record for that vehicle.

The first set of filter rules may include a variety of filters. According to one embodiment the first set of filter rules comprises an age filter to filter out vehicles based on model years. In another embodiment, the first set of filter rules comprises a mileage filter to filter out vehicles based on mileage.

The set of computer executable instructions can be further executable to: for each vehicle in the second set of inventory feed records, enhance an inventory record with data from remote information provider systems. The set of computer executable instructions can be further executable to apply a second set of filter rules to the second set of inventory records. According to one embodiment, the data from the remote information provider systems comprises a wholesale value and the second set of filter rules comprises a filter rule to filter out vehicles having an associated dealer price that is not within a specified range of the wholesale value.

According to one embodiment, for each vehicle in the program pool, the system can determine a current value of the vehicle, determine a residual value of the vehicle at each of a plurality of terms by applying the corresponding depreciation curve to the current value, calculate a payment schedule for the vehicle based on the residual values of the vehicle and a unit economics model and store the payment schedule as a pre-calculated payment schedule for the vehicle in the inventory record for the vehicle. Calculating the payment schedule for a vehicle can include calculating the payment schedule for each of a plurality of mileage bands. Calculating the payment schedule for each of a plurality of mileage bands comprises calculating the payment schedule so that a plurality of ROA hurdles are met.

The rules-based data processing system may further comprise a machine learning regression model having independent variables representing features of vehicles and having a dependent variable that indicates an expected value of a vehicle, wherein the set of computer executable instructions are executable to use the regression model to determine the depreciation curves.

The rules-based data processing system can publish inventory records corresponding to the program pool, the published inventory records retrievable based on payment schedule.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a high level block diagram of one embodiment of a network topology.

FIG. 2 is a block diagram illustrating one embodiment of inventory processing.

FIG. 3 is a block diagram of one embodiment of a process for developing a pricing model and depreciation models.

FIG. 4 is a flow chart illustrating one embodiment of determining payment schedules for a vehicle.

FIG. 5 is a flow chart illustrating one embodiment of a purchase process.

FIG. 6A, FIG. 6B, FIG. 6C, FIG. 6D and FIG. 6E illustrate one embodiment of a series of mobile application pages corresponding to a purchase process.

FIG. 7 depicts a diagrammatic representation of a distributed network computing environment.

### DETAILED DESCRIPTION

The invention and various features and advantageous details thereof are explained more fully with reference to the exemplary, and therefore non-limiting, embodiments illustrated in the accompanying drawings and detailed in the following description and appendices. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Embodiments relate to a rules-based data processing system. More particularly, embodiments relate to a rules/model-based data processing system that receives inventory feed records from remote sources, enhances the inventory data with data from distributed sources and filters inventory records down to a set of inventory records for vehicles (or other assets) based on rules/models. The computer system provides a program pool of vehicles that reduces the large number of vehicles that a consumer must typically search through to vehicles that are fairly priced. According to one aspect of the present disclosure, the computer system receives inventory records from remote sources, enhances the inventory records with information from other, distributed sources, and applies “fair value” rules to the inventory records to filter the inventory items down to a program pool of inventory items that have a “fair value” based on the fair value rules. In accordance with one embodiment, the fair value rules are selected such that each inventory item (e.g., vehicle) in the program pool is priced close to its wholesale value or other value at the time of sale and can be accurately and competitively priced based, for example, on the output of a machine learning model and selected metrics.

The computer system applies pricing rules/models (including, in some embodiments, machine learning models) to the program pool of inventory records to accurately determine an initial payment and monthly (or other periodic) payments for each inventory item. The payments may be selected to meet particular metrics. In one embodiment, the computer system determines a plurality of payment schedules for an inventory item corresponding to different combinations of values of application, order or other parameters. As one example, the computer system can be configured to determine prices for various combinations credit risk, usage and option parameter values. The payments for an inventory item can be pre-calculated before an inventory item is presented to a consumer making the system more efficient, particularly over a large number of inventory records.

The inventory items made available for selection by the user in the client application may be specifically curated for that user by the computer system based on the user's ability to afford the inventory items. As noted above, the computer system can pre-calculate the payment schedules for each inventory items and independently “pre-approve” financing for the consumer. The computer can thus limit the inventory items presented to the user based on the user's approved payment amount.

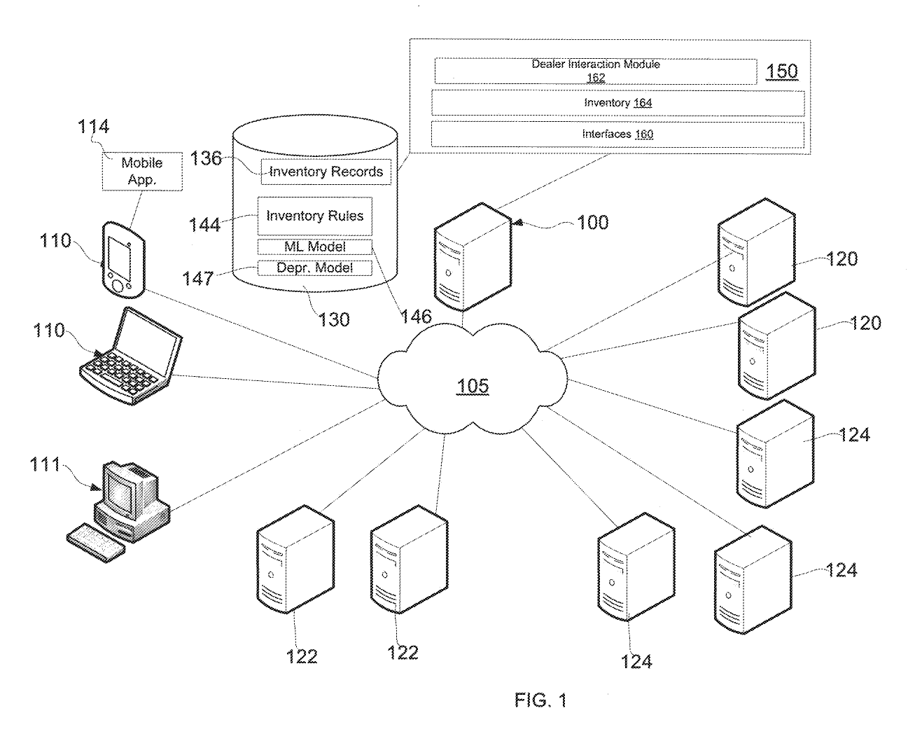

Embodiments of the systems and methods of the present invention may be better explained with reference to FIG. 1, which depicts one embodiment of a topology which may be used to implement certain embodiments. The network topology of FIG. 1 comprises an automotive data processing system 100 which is coupled through network 105 to client computing devices 110 (e.g. computer systems, personal data assistants, smart phones or other client computing devices). The topology of FIG. 1 further includes one or more information provider systems 120, one or more dealer management systems (DMS) 122, inventory systems 124 or other systems. Network 105 may be, for example, a wireless or wireline communication network such as the Internet or wide area network (WAN), publicly switched telephone network (PTSN) or any other type of communication link.

In accordance with one aspect of the present disclosure, automotive data processing system 100 provides a comprehensive computer system for automating and facilitating a purchase process including financing qualification, inventory selection, document generation and transaction finalization. Using a client application 114 executing on a client device 110, a consumer user may apply for financing, search dealer inventory, select a vehicle of interest from a dealer and review and execute documents related to the purchase of the vehicle, and execute automated clearing housing (ACH) transactions through automotive data processing system 100 to purchase the vehicle from the dealership. The automotive data processing system 100 may initiate the consumer's fee payments through various payment methods. Automotive data processing system 100 may be provided by or behalf of an intermediary that finances the purchase of a vehicle by a consumer from the dealer. In this context, a “consumer”, is any individual, group of individuals, or business entity seeking to purchase a vehicle (or other asset) via the system 100.

Turning briefly to the various other entities in the topology FIG. 1, dealers may use a dealer management system (“DMS”) 122 to track or otherwise manage sales, finance, parts, service, inventory and back office administration needs. Since many DMS 122 are Active Server Pages (ASP) based, data may be obtained directly from a DMS 122 with a “key” (for example, an ID and Password with set permissions within the DMS 122) that enables data to be retrieved from the DMS 122. Many dealers may also have one or more web sites which may be accessed over network 105, where inventory and pricing data may be presented on those web sites.

Inventory systems 124 may be systems of, for example, one or more inventory polling companies, inventory management companies or listing aggregators which may obtain and store inventory data from one or more of dealers (for example, obtaining such data from DMS 122). Inventory polling companies are typically commissioned by the dealer to pull data from a DMS 122 and format the data for use on web sites and by other systems.

Information provider systems 120 may be systems of entities that provide information used in approving a user or purchase. Examples of information provider systems 120 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 120 may comprise any number of other various sources accessible over network 105, which may provide other types of desired data, for example data used in identity verification, fraud detection, credit checks, credit risk predictions, income predictions, affordability determinations, residual value determinations or other processes.

Automotive data processing system 100 may comprise one or more computer systems with central processing units executing instructions embodied on one or more computer readable media where the instructions are configured to perform at least some of the functionality associated with embodiments of the present invention. These applications may include a vehicle data application 150 comprising one or more applications (instructions embodied on a computer readable media) configured to implement one or more interfaces 160 utilized by the automotive data processing system 100 to gather data from or provide data to client computing devices 110, information provider systems 120, DMS 122, inventory systems 124 and processing modules to process information.

Automotive data processing system 100 utilizes interfaces 160 configured to, for example, receive and respond to queries from users at client computing devices 110 interface with information provider systems 120, DMS 122, inventory systems 124, obtain data from or provide data obtained, or determined, by automotive data processing system 100 to any of information provider systems 120, DMS 122, inventory systems 124. It will be understood that the particular interface 160 utilized in a given context may depend on the functionality being implemented by automotive data processing system 100, the type of network 105 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, APIs, libraries or other type of interface which it is desired to utilize in a particular context.

Vehicle data application 150 can comprise a set of processing modules to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 1, vehicle data application 150 includes a dealer interaction module 162 which can provide a service to allow dealers to register with automotive data processing system 100 to allow vehicles to be purchased through automotive data processing system 100. To onboard a dealer, a dealer account may be established at automotive data processing system 100. Various pieces of information may be associated with the dealer account. Once a dealer is on-boarded, dealer interaction module 162 may provide a dealer portal (e.g., a web site, web service) through which the dealer may access and update information for transactions using, for example, a browser at a dealer client computer 111. The dealer portal may also include a history of previously completed deals and other information.

As part of onboarding, automotive data processing system 100 can be provided with credentials or other information to allow automotive data processing system 100 to access dealer inventory information from the dealer's DMS 122 or an inventory system 124. In addition or in the alternative other channels may be established to retrieve inventory information (e.g., email, FTP upload or other channel).

The dealer may provide any forms that are required during a sales transaction. For example, state DMVs often mandate specific disclosures and some dealers have their own required disclosure documents that go beyond what is required by the government. The dealer may also provide bank account information to allow funds to be transferred to the dealer to purchase vehicles.

Inventory module 164 receives inventory feeds from remote sources via the channels established with the dealers, enhances the inventory records with information from other, distributed sources, and applies inventory rules 144 to the inventory records to filter the inventory items down to a program pool of inventory items that have a fair value (in this context, whether an inventory item has a “fair value” is objectively determined based on the rules applied). In accordance with one embodiment, the rules are selected such that each inventory item (e.g., vehicle) in the program pool is priced close to its wholesale value, current market value or other value at the time of sale and can be accurately and competitively priced based on selected metrics.

Inventory rules 144 may further include rules for pricing vehicles based, for example, on a pricing model 146. Automotive data processing system 100 uses the model, or more depreciation models 147 derived from the model 146, to accurately determine an initial payment and monthly (or other periodic) payments for each inventory item. The payments may be selected to meet particular metrics. As discussed below, the payments for each vehicle may include payments to cover the modeled depreciation of the vehicle in addition to other products.

In some embodiments, system 100 may determine an array of payments for each vehicle, the array containing payments for multiple mileage and credit risk bands. Inventory module 164 may store an inventory record 136 for each vehicle in the vehicle pool, the inventory records containing data obtained from inventory feeds, enhanced data from information provider systems 120 and payment schedules. Inventory module 164 may further search inventory records 136 in response to search criteria received from a client computing device 110.

Furthermore, automotive data processing system 100 may include data store 130 operable to store obtained data, processed data determined during operation and rules/models that may be applied to obtained data or processed data to generate further processed data. In one embodiment, automotive data processing system 100 maintains user applications, orders and inventory objects. Further, in the embodiment illustrated, data store 130 is configured to store rules/models used to analyze inventory data, such as inventory rules 144, machine learning model 146 and depreciation models 148. Data store 130 may comprise one or more databases, file systems or other data stores, including distributed data stores managed by automotive data processing system 100.

Client computing devices 110 may comprise one or more computer systems with central processing units executing instructions embodied on one or more computer readable media where the instructions are configured to interface with automotive data processing system 100. A client computing device 110 may comprise, for example, a desktop, laptop, smart phone or other device. According to one embodiment, a client computing device 110 is a mobile device that has a touchscreen display and relies on a virtual keyboard for user data input. According to one embodiment, the client application 114 may be a mobile application (“mobile app”) that runs in a mobile operating system (e.g., Android OS, iOS), and is specifically configured to interface with automotive data processing system 100 to generate application pages for display to a user. In another embodiment, the client application 114 may be a web browser on a desktop computer or mobile device.

In accordance with one embodiment, a user can utilize client application 114 to register with automotive data processing system 100, apply for financing, view inventory, select a vehicle, review documents and finalize a sales transaction through a low friction mobile app running on a smart phone. Client application 114 can be configured with an interface module to communicate data to/from automotive data processing system 100 and generate a user interface for inputting one or more pieces of information or displaying information received from automotive data processing system 100. In some embodiments, the app 114 may comprise a set of application pages through which app 114 collects information from the user or which client application 114 populates with data provided via an interface 160.

Any type of information may be received from the consumer user in accordance with embodiments of the present disclosure, including consumer information, (such as personally identifiable information (PII) and financial information for that user), order parameters, such as vehicle features (such as the make, model, year, mileage, trim, or other characteristics of a specific vehicle or group of vehicles in which the consumer is interested) and order payment parameters (other parameters that affect the monthly payment, such selections of additional products, an indication of expected usage or other parameters) or other information. Vehicle data application 150 can return responsive data, such as an approved financing amount (e.g., approved monthly payment for the user), vehicles that match search criteria and other information.

It should be noted here that not all of the various entities depicted in the topology are necessary, or even desired, in embodiments of the present invention, and that certain of the functionality described with respect to the entities depicted FIG. 1 may be combined into a single entity or eliminated altogether. Additionally, in some embodiments other data sources not shown in FIG. 1 may be utilized. FIG. 1 is therefore exemplary only and should in no way be taken as imposing any limitations on embodiments of the present invention.

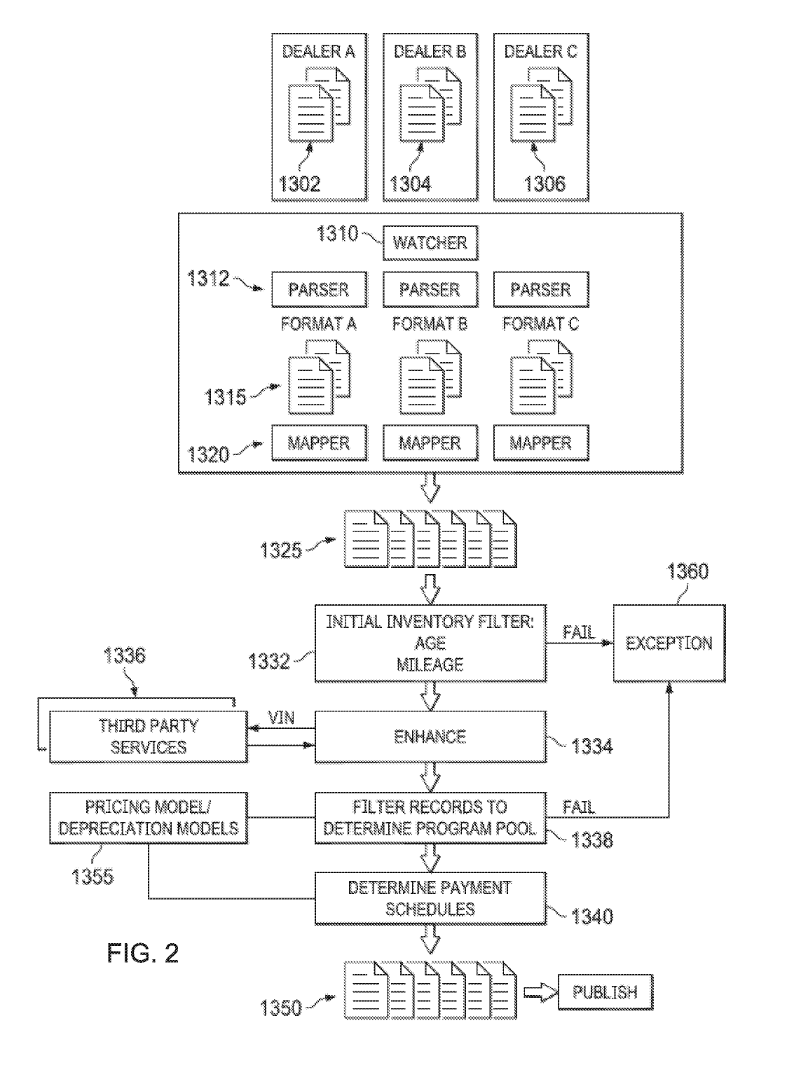

The vehicles made available for purchase through automotive data processing system 100 can be screened to determine which ones are priced appropriately to qualify as candidates to be put into system. Automotive data processing system 100 then determines payment schedules for the vehicles. The determination of a payment schedule may depend on a pricing model. FIG. 2 is a block diagram illustrating one embodiment of inventory processing that may be performed by data processing system 100. More particularly, according to one embodiment, inventory module 164 may perform inventory processing.

Automotive data processing system 100 receives inventory feeds from DMS 122, inventory systems 124 or via other channels. For example, automotive data processing system 100 may receive inventory files (such as CSV files) from various dealers uploaded to an FTP site. In other embodiments, automotive data processing system may collect inventory information by making appropriate API calls to a DMS 122 or inventory system 124.

The inventory feeds include inventory data for inventory associated with registered (on boarded) dealers and pricing information. Different dealers or DMS systems, however, may use different data formats. Automotive data processing system 100 can apply rules to extract inventory information from the various feeds and normalize the data into an internal format.

An inventory feed record, which may include information from one or more sources, can include information such as a VIN, segment, manufacturer, model, model year, trim level, engine displacement, drive type, series lifecycle, vehicle condition, geographical region, type of sale, options, color, remaining OEM or CPO warranty coverage, dealer asking price, dealer odometer reading, dealer description of the vehicle. It may be noted that, in some cases, an inventory feed record may only provide a limited amount of information, such as VIN, year/make/model, dealer odometer reading, dealer asking price. As discussed below, the inventory data from an inventory feed may be enhanced with data from other network locations.

Different dealers or DMS systems may use different data formats. Automotive data processing system 100 can apply rules to extract inventory information from the various feeds and normalize the data into an internal format. For each VIN, the automotive data processing system 100 can create a normalized inventory feed record 1350.

In the illustrated example, dealer A uploads inventory files 1302 in a first format to a first FTP site, dealer B provides inventory files 1304 in a second format to a second FTP site and dealer C uploads inventory files 1306 in a third format to a third FTP site. According to one embodiment automotive data processing system 100 can comprise a watcher process 1310 that watches for new inventory feed events, such as a file being uploaded to an FTP site, and initiates a processing job to process the inventory feed records. Thus, processing jobs can begin as soon as an inventory file is uploaded.

Based on watcher 1310 determining that a new inventory file has been uploaded or an inventory feed otherwise received, vehicle data application 150 can read and process the feed. According to one embodiment, vehicle data application 150 can be configured to parse the CSV files (or other input data) to extract inventory feed records for individual vehicles. Therefore, vehicle data application 150 may include parsers 1312 dedicated to each input format and configured to parse out individual inventory feed records 1315 from inventory files. Moreover, vehicle data application 150 can include format mapping modules 1320 configured to map extracted inventory feed records from different dealer formats into inventory records in a normalized internal format. For example, each mapping module may be configured to extract delimited data from CSV records and map the delimited data to normalized fields to create normalized inventory feed records 1325.

Vehicle data application 150 may apply initial inventory filter rules 1332. Initial inventory filter rules 1332 may include rules to filter out records based on a variety of factors. An initial set of filters may filter out inventory records with incomplete or duplicative data or based on other criteria. For example, rules may be applied to filter out vehicles for which the asking price is above a particular maximum price, vehicles outside of particular geographic regions, new vehicles or based on other criteria.

In particular, one or more inventory rules 144 may be applied to create a program pool of inventory items for which competitive payments that account for deprecation can be accurately established. The inventory rules may include a set of “fair value” filters configured to ensure that for each vehicle in the program pool i) there is sufficiently reliable residual value data for the vehicle for the expected life of an ownership agreement, plus a reasonable margin of error; ii) the vehicle is priced at a point that reasonably reflects fair market value and allows a payment schedule to be established that is competitive; iii) the vehicle remains affordable to the consumer through the predicted life of an ownership agreement; iv) the vehicle is fairly priced to the consumer such that all customers are protected against buying a car that is objectively overpriced. While, as discussed above, some tools help the consumer in negotiation, automotive data processing system 100 can eliminate negotiation by pre-determining fair payment schedules for vehicles before a consumer looks at the vehicles.

In general, the cost of ownership of a vehicle becomes more difficult to predict as a car increases in mileage because the frequency of higher dollar scheduled maintenance requirements and the frequency and severity of repairs increases with higher mileage vehicles, and the amount of secondary market data utilized for residual value estimation decreases. When aggregate MR (maintenance, repair) expenses are analyzed, the cumulative MR expense during the OEM warranty period is low and generally linear (consisting of mainly oil changes and other lower dollar preventative maintenance), but after the vehicle exits the warranty period, the MR expenses increase at an increasing rate due to the increasing frequency and severity of MR occurrences. Therefore, both the maintenance and repair expenses and depreciation become harder to predict for vehicles at higher mileages. The mileage at which cost-of-ownership tends to ramp up may depends on vehicle or other factors.

It can be noted, however, that other age caps may be used depending on the availability of reliable wholesale data or residual value data or the ability to model residual value data for older vehicles. Moreover, different age caps may be set for different vehicles depending on, for example, the reliability of the vehicle year/make/model, remaining warranty or other factors.

Rules may be established to filter out vehicles based on model years. Residual value data becomes less reliable for predicting the actual residual value for a vehicle in the future the older the vehicle is. As such, an age limit for vehicles entering the program pool can be set to limit the number of vehicles over a certain age that will be under ownership agreements. For example, it may be desirable to limit the number of vehicles over 7 models years old that will be under ownership agreements (e.g., because it has been determined that residual value data is less reliable for older vehicles) and the predicted average life of ownership agreements is 18 months, a filter rule can be established to filter out vehicles of greater than 4 model years old. In this example, 4 years can be selected because the expected average hold time for vehicles is 18 months with the further expectation that only a very small percentage of consumers will hold vehicles for more than 36 months. This means that most ownership agreements will terminate before the subject vehicles are more than 7 model years old.

Thus rule can be established to filter out vehicles of greater than 4 model years old or other age limit. As another example, a filtering rule may filter out vehicles based on a maximum mileage threshold, for example, 30,000, 50,000 or other mileage. Different age and mileage caps may be set for different vehicles depending on, for example, the reliability of the vehicle year/make/model, remaining warranty or other factors.

Furthermore, age can act as a proxy for mileage. In general, the frequency of higher dollar scheduled maintenance requirements and the frequency and severity of repairs increases with mileage. When aggregate MR (maintenance, repair) expenses are analyzed, the cumulative MR expense during the OEM warranty period is low and linear (mainly oil changes), but after the vehicle exits the warranty period, the MR expense increases and also starts to bend upward due to the increasing frequency and repairs of MR occurrences. Vehicles that are under 7 years old are more likely to remain under the mileage at which cost-of-ownership tends to ramp up.

Rules may be established to filter out vehicles based on mileage. For reasons discussed above, it may desirable to limit the maximum mileage of cars presented by automotive data processing system 100. For example, the maximum mileage can be set to 30,000, 50,000 or other mileage. Again, this can help prevent vehicles subject to ownership agreements from reaching extreme mileage during the life of the ownership agreements. It can be noted, however, that other mileage caps may be used depending on the availability of reliable wholesale data or residual value data or the ability to model residual value data for higher-mileage vehicles. Different mileage caps may be set for different vehicles depending on, for example, the reliability of the vehicle year/make/model, remaining warranty or other factors.

For inventory feed records that are not filtered out at step 304, automotive data system 100 can create an inventory record for the respective vehicle (VIN) or, if an inventory record for the VIN exists in system 100 already, update the inventory record for the vehicle.

At 1334, the automotive data processing system 100 interfaces with one or more distributed information provider systems 120 to enhance the inventory record. For example, automotive data processing system 100 may use APIs to collect relevant data from a number of third party services 1336. Note that each API call may be associated with a staleness check. A particular set of enhanced inventory data is not collected again for a vehicle unless the data is considered stale. When enhanced inventory data is collected for a VIN, the inventory record for a VIN may be updated with the date at which data was collected from the particular service 1336.

According to one embodiment, automotive data system 100 can send a VIN (and some cases additional data) to one or more automotive description service information provider systems 120, receive information associated with each VIN in response and enhance the inventory record for the VIN based on the received information. For each VIN in an inventory feed, automotive data processing system 100 can check when description service data from the automotive description service information provider was last checked (if ever) for that VIN and if the information for that VIN is not stale (e.g., was checked within the last x days by automotive data processing system 100), request the description information from the automotive description service. Automotive description services can provide information such as year, make, model, trim, style, color, technical specifications, standard equipment, installed options for a VIN, stock images for the make/model/trim and other information. One example of an automotive description service is the ChromeData service provided by Autodata, Inc. of Portland, Oreg.

Automotive data processing system 100 can further enhance an inventory record with vehicle history data. According to one embodiment, automotive data processing system 100 may obtain vehicle history reports from a vehicle history information system (which can be an example of an information provider system 120). For example, Carfax, Inc. of Centerville, Va. provides a vehicle history reporting service. As another example, Experian provides the Autocheck vehicle history report service. For each VIN in an inventory feed, automotive data processing system 100 can check when vehicle history data from the vehicle history reporting service was last checked (if ever) for that VIN and if the information for that VIN is not stale (e.g., was checked within the last y days by automotive data processing system 100), request the vehicle history information system.

Automotive data processing system 100 can further enhance a vehicle inventory record with a current value. For example, various third party information provider systems 120 provide trim matching services that provide a current wholesale value based on year/make/model/trim and odometer reading. For example, Manheim Auctions, Inc. of Atlanta, Ga. (“Manheim”) provides current wholesale values for vehicles based on year/make/model/trim and odometer (known in the industry as the Manheim Market Report (MMR)). Manheim can also provide historical wholesale values (2 weeks ago, 4 weeks ago, 2 months ago, 6 months ago, etc.) Similarly, Kelly Blue Book of Irvine, Calif., provides current wholesale values for vehicles. Automotive data processing system 100 can check when wholesale value data from the wholesale pricing system was last checked (if ever) for that VIN and odometer reading and if the information for that VIN and odometer reading is not stale (e.g., was checked within the last z days by automotive data processing system 100), request the wholesale pricing information for that vehicle using, for example, the VIN and current odometer reading from the inventory record.

Based on the enhanced inventory records, automotive data processing system 100 can further filter vehicles to determine vehicles in the program pool. Examples of additional fair value filters that can be applied include, by way of example:

Model/trim: A wholesale pricing system may not have a current value for a particular year/make/model/trim. Vehicles for which the wholesale pricing system does not return a current value can be filtered out. Furthermore, automotive data processing system 100 can filter out a vehicle if there is insufficient data to match the vehicle to a pre-determined residual value model.

Vehicle history: Vehicles may be filtered based on vehicle history. Rules can be applied to the vehicle history information to exclude vehicles. Rules may be established to exclude vehicles based on, for example, accidents, airbag deployment, structural damage, branded title or other title marks, odometer info or other items.

Price: In some embodiments, vehicles can be filtered based on price. The intermediary may only wish to offer vehicles that are priced near fair market value at sale. As such, rules may be established to filter out vehicles that, according to the rules, are over-priced. Price filtering may be based, for example, on wholesale value. In one embodiment, for example, automotive data processing system may filter out vehicles that exceed the wholesale value for the vehicle configuration (e.g., make/model/year/options/mileage, etc.) by a specified dollar or percentage cap.

A rule can be established such the vehicles must be priced within a set % cap (e.g., 110-120% or other percentage) or dollar value of a trusted price index such as “above [average condition] MMR” price or other wholesale values indicated for the vehicle configuration (“above MMR” is a metric known in the industry that considers vehicle condition in the valuations). The price filter helps ensure that each vehicle is priced close to the residual value model (or other model) for that vehicle at the beginning and that consumers are not overpaying for vehicles. In addition, a price filter may be applied to filter out vehicles that are priced too low compared to a trusted index.

In another embodiment, the vehicle year/make/model/trim, odometer reading can be input into a pricing model (discussed below) to determine a current value (0 term) based on the pricing model to determine a model-based current value. Rules can implemented to filter out vehicles that are not within thresholds (percentage or dollar value) of the model-based current price.

In accordance with one embodiment, records that do not meet the filter criteria applied at 1332 and 1338 can be added to a queue of exceptions 1360. These exceptions may be made available to a dealer so that the dealer understands why a vehicle failed to be placed in the program pool. For example, vehicles offered by a dealer that exceed the price limit set for the price filter but otherwise pass the filtering rules (the “price excluded set”) can be displayed to dealer in the dealer portal. The maximum price allowed by the price filter may also be displayed for each vehicle. The dealer can see their price and the maximum price allowed by the filter for each vehicle and may be given the option to “Set Price To Max” to set the price on any particular vehicle or their entire price excluded set to the corresponding maximum price. Vehicles set at maximum filter price can be included in the next update.

A number of the above-referenced filters may be applied to pre-filter inventory before accepting the inventory into the system or before displaying an inventory item to a consumer. Additional filters may also be applied to post-filter inventory records after inventory records have entered the system. For example, in one embodiment, automotive data processing system 100 may obtain a more detailed vehicle history report when a user selects a particular vehicle and filter the vehicle based on the additional vehicle history report information. In one embodiment, automotive data processing system may obtain additional vehicle history report information from the Autocheck service and apply rules to remove a vehicle based on one or more of title issues, deployed airbag, major accident, auction notes, exterior/weather/fire/water damage, theft, repossession or other items.

According to one embodiment then, the inventory records stored by automotive data processing system 100 can include inventory records that passed the pre-filters and have not been eliminated by a post-filter and inventory records that passed all the pre-filters except price and have not been eliminated by a post-filter.

At 1340, automotive data processing system 100 is configured to apply payment models/depreciation models 1355 to determine initial and monthly payments for vehicles in a program pool where the payments are selected to achieve desired metrics. In accordance with one embodiment, the payments may be selected to allow the user to return a vehicle at any time while still being viable for the intermediary. The initial payment and monthly payment can be determined in a manner that does not require any information about a consumer. Consequently, these values can be pre-determined for vehicles before the vehicles are presented to a consumer and can be used by automotive data processing system 100 to pre-populate ownership agreements or other documents. An inventory record 1350 can thus be enhanced with one or more payment schedules for a vehicle.

Automotive data processing system 100 can be configured with a plurality of mileage bands (e.g., 0-10,000 mi/yr, 10,001-12,500 mi/yr . . . ) so that when a user selects a vehicle to purchase, the user may select an expected mileage band (how many miles a year the user expects to drive the vehicle). A payment schedule can be determined for each mileage band and stored in the inventory record 1350.

Moreover, automotive data processing system 100 may categorize users into credit risk bands, for example:
If FICO 700-710 then credit risk=19
IF FICO 711-720 then credit risk=18
IF FICO 721-730 then credit risk=17
IF FICO 731-740 then credit risk=16
* * *
IF FICO 890-900 then credit risk=0

A payment schedule can be determined for based on each combination of credit risk/mileage band and stored in the appropriate inventory record 1350. In other embodiments, a single payment schedule is determined, the single payment schedule corresponding to a default mileage band (e.g., 10,000 mi/yr) or default combination of credit risk and mileage band.

Filters can be reapplied or payment schedules determined again responsive to underlying data changes. For example, if the inventory record odometer reading for a vehicle changes, automotive data system 100 can re-determine the current price for the vehicle and reapply the various filters to determine if the vehicle still qualifies to be in the program pool. As another example, automotive data processing system 100 may periodically recheck third party services 1336 for data changes, such as changes to the wholesale value.

At step 1352, the automotive data system 100 can publish an inventory record for a vehicle to a front-end. Publication may include copying the inventory record to a different data repository that is accessible by a front-end system. The inventory record, when published, can include base start fees and monthly payments for multiple credit risk bands and mileage bands.

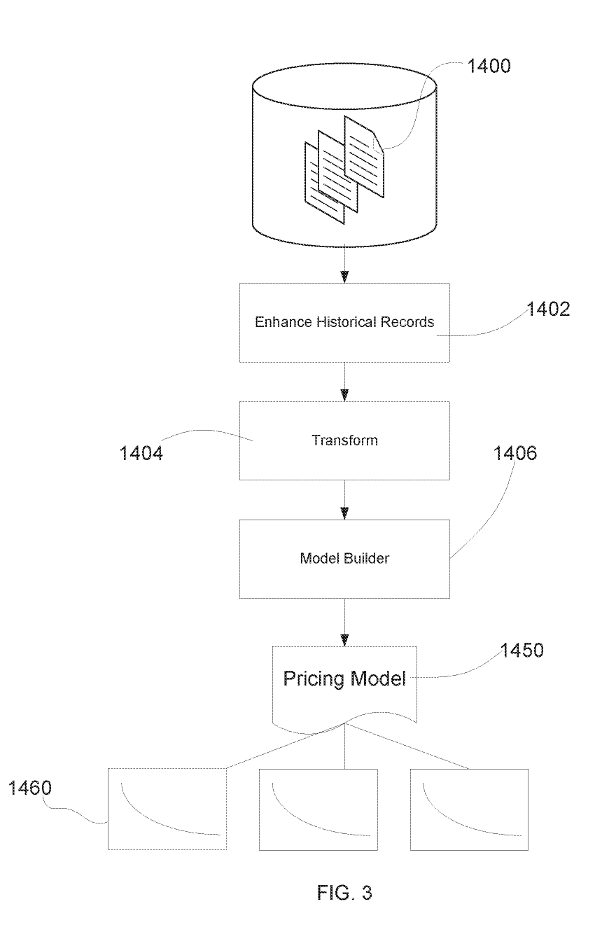

FIG. 3 is a block diagram of one embodiment of a process for developing a pricing model and depreciation models. The determination of payment schedules may rely on a pricing model 1450 (a residual value model) that can be used to predict secondary market depreciation rates, on a unit level, based on select model specific, usage, industry, and macroeconomic variables, examples of which are provided below. Through machine learning and training, the particular variables of interest (including potentially different or additional variables) and weights can be determined.

According to one embodiment, model 1450 may be a regression coefficient model. The dependent variable of model 1450, may be a year/make/model/trim expected secondary market sale price at a target duration and mileage band (for example, expressed as a percentage of current market value). Examples of independent variables include, but are not limited to: i) vehicle variables-segment, make, model, model year, trim, engine displacement, drive type, series life cycle, vehicle condition, geographic region, type of sale, options, color, remaining OEM or CPO warranty coverage; ii) usage variables-annual mileage, disposal, sales month, months in service; iii) industry variables-new vehicle registrations, fleet penetration, rental penetration; iv) macroeconomic variables-GDP, unemployment, interest rates, secondary market seasonality, household disposable income, fuel prices, CPI, Mannheim Used Vehicle Value Index by Mannheim.

Model 1450 can be trained on a set of historical data 1400. According to one embodiment, historical auction transaction data may be used. The auction transaction data is non-aggregated data that includes information regarding the date, year, make, model, trim, mileage, sales price and other information for individual vehicles sold at auction. For example, a residual value model may be trained using auction data from the National Automobile Dealers Association (NADA) of Tysons, Va. In some cases, the auction transaction data can be enhanced with data from other sources (1402).

The historical data may be transformed (1404) into a form that can be ingested by a model builder 1406. For example, text data may be mapped to numerical data and other transformations applied. The historical data may be input into a model builder, such as the open source scikit-learn (sklearn) tool to generate a pricing model 1450.

The pricing model can be periodically retrained on new data from a third party provider or internal data collected by automotive data processing system 100 over time. As such, the residual value determination may thus become increasingly accurate with additional data and adjust to changing trends.

The residual value model may contextualize data analysis. For example, one piece of information (or combination thereof) may be analyzed differently depending on the results of analyzing another piece of information (or combination thereof).

As described above, the dependent variable may be a year/make/model/trim expected secondary market sale price at a target duration (1 month, two month, etc.) and mileage band (estimate for vehicle driven an average of 10,000 a year, 10,001-12,500 miles a year, etc.). Thus, the model can be used to develop depreciation models 1460. Each depreciation model may correspond to a year/make/model/trim and mileage band. For example, the system may generate a depreciation curve (a depreciation model) for a default mileage band (say 10,000 miles-a-year) and excess mileage may addressed by contractual terms (excess mileage fees). In other embodiments, vehicle data application 150 determines the depreciation models for each mileage band supported. For example, for a specific year/make/model/trim, vehicle data application 150 can determine a 10,000 mile-a-year depreciation curve, a 12,500 mile-per-year curve, etc., up to a maximum mileage band supported by the system 100.

Depreciation models are not generated for vehicle configurations (year/make/model/trim) for which there was insufficient data input to build the model 1450 (e.g., less than a certain number of records in historical data 1400 or based on other metric). As discussed above, if a depreciation curve is not available for a year/make/model/trim in an inventory record, the inventory record can be filtered out (step 1338).

The pricing model parameters and depreciation models 1460 (e.g., the curve coefficients, intercepts or other data defining the depreciation curves) may be stored. It can be noted that, in many cases, depreciation for a year/make/model/trim/average usage is often linear (a steady percentage), at least while a vehicle is less than a particular age and mileage (usually about 7 years and 100,000 miles) and the inventory filter rules can be selected so that the vehicles in the program pool are in and likely to stay in the region in which depreciation ratio is linear. Thus, the depreciation model 1460 for a year/make/model/trim and mileage band may be a simple percentage in some embodiments.

The residual value model 1450 can be periodically retrained on new data from a third party provider or internal data collected by automotive data processing system 100 over time. As such, the residual value determination may thus become increasingly accurate with additional data. The residual value model may contextualize data analysis. For example, one piece of information (or combination thereof) may be analyzed differently depending on the results of analyzing another piece of information (or combination thereof).

The payment schedule(s) for a vehicle may be determined in a variety of manners. According to one embodiment, the payment schedule is selected so that the combination of start fee and monthly payments stay ahead of the depreciation curve for the vehicle. The payment schedule may also be selected based on other considerations.

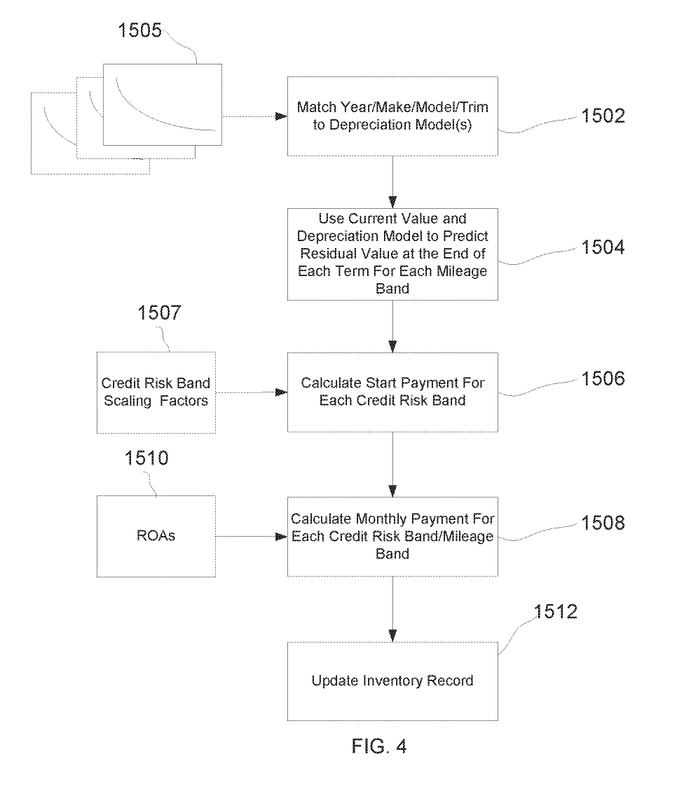

FIG. 4 is a flow chart illustrating one embodiment of determining base payment schedules for a vehicle. In the embodiment of FIG. 4, the payment schedule for a vehicle is determined on a unit economics model based on particular metrics, discussed below. At step 1502, the year/make/model/trim is determined and the appropriate depreciation model(s) 1505 loaded (for example one or more depreciation models 1460 developed from the machine learning pricing model 1450). At step 1504, a depreciation model is applied to the current value of the vehicle to determine the predicted value of the vehicle at the end of each term out to a configured term (e.g., the value at the end of month 1, month 2, month 3 etc. to say 72 months or other maximum term). The estimated residual values for each term can be determined for each mileage band. In one embodiment, the current value is the MMR value for the VIN or other trusted index value of wholesale value. In another embodiment, the current value may be determined from a machine learning model, such as pricing model 1450 (e.g., using 0 term).

The data processing system determines one or more base start fees for the vehicle. For example, the base start fee may be 5% (or other percentage) of the dealer's asking price for the vehicle. The base start fee may be adjusted up or down based on credit risk band. According to one embodiment, credit scores may be categorized into credit risk bands and each credit risk band assigned a scaling factor. As such, at 1506, the data processing system may load a set of scaling factors 1507 for credit risk bands. For example, a first credit risk band corresponding to riskier credit scores, may be assigned a factor of 2, high credit scores (an example of a second credit risk band) may be assigned a factor of 0.5 and credit risk bands in between may be assigned factors between 0.2 and 2. In this example, automotive data processing system 100 determines a range of start fees (one for each credit risk band) from 1% of dealer asking price to 10% of dealer asking price. In another embodiment the base start fee is determined along with the monthly payments (step 1508) as a simple multiple of the monthly payments.

At 1508, automotive data processing system 100 determines the base monthly payments for the vehicle. The base monthly payments for the vehicle are determined based metrics. According to one embodiment, return-on-asset (ROA) hurdles 1510 can be set for various terms (e.g., 6 months, 12 months, 18 months, etc.). Moreover, different ROA hurdles can be set for different credit risk bands. For example, the 6, 12 and 18 month ROA hurdles for a higher credit risk band may be higher than the 6, 12 and 18 month ROA hurdles for a lower credit risk band. According to another embodiment, the same ROA hurdles are used regardless of credit risk band. The base monthly payments and/or start fee can be adjusted such that the start fee and monthly payments achieve an ROA hurdle or set of ROA hurdles. For example, the system can start at a default monthly payment amount, say $0, and add a $1 until all the ROA hurdles are met.

The ROA calculation can be performed according to methods known or developed in the art with actual or assumed cost of funds. According to one embodiment, the ROA for a term “t” can be calculated as follows:

$${ROA}_{term} = \frac{{\sum }_{t = 1}^{t = term} {returns}_{t}}{{\sum }_{t = 1}^{t = term} asset {value}_{t}}$$

The foregoing is based on the following monthly balance sheet items for the particular vehicle for each month:
1) asset value: predicted value of asset at term t as predicted from the residual value prediction models (e.g., depreciation models).
2) returns: expected cash flows associated with the vehicle (net income on the vehicle). The cash outflows can include direct costs associated with the particular vehicle items. The cash outflow may include items such as the cost of money, payments made by the intermediary to finance the vehicle or other cash outflows specific to the vehicle. The cash outflow each month may include an amount that models or predicts the risk that the user will default in that month. For example, if it is predicted that there is 0.1% chance that a vehicle will be reposed in any given month and the cost of a repossession is $1000, then a cash outflow can include a $1 fee for the month. Other predicted losses may be included in the cash outflows. In some cases, there are direct costs that are passed directly to the consumer, such as dealer doc fees and other fees. Such costs may be included in the model, but may be ignored as they will have a directly corresponding and equal cash inflow.

In the first month, the cash inflow from the base start fee, the first monthly payment and the cash outflow from the payment to the dealer and other costs associated with the purchase can be represented. Each month can include the monthly payment for vehicle. Moreover, for any given return month, it can be assumed that the vehicle will be sold for the predicted residual value and the monthly cash flow for a term can include the cash flow for the hypothetical sale of the vehicle at that term (e.g., ROA₆ can assume the vehicle is returned and sold in month six). The predicted residual value can be calculated by applying the depreciation model to the current value determined for the vehicle.

For example, automotive data processing system may be configured with ROA hurdles as follows: 6 months 0%, 12 months 0.5%, 18 months 1% (the values are provided by way of example). The base monthly payments can be adjusted until the payments yield ROA₆>=0, ROA₁₂>=0.5, ROA₁₈>=1. As discussed above, the ROA hurdles may depend on credit risk band.

As discussed above, the ROA goals may vary based on credit risk band. As such vehicle data application 150 can determine a fee schedule for each credit risk band. Moreover, as will be appreciated, the predicted residual value for a vehicle at a given term will depend on expected depreciation, which, in turn, depends on expected usage (mileage band). According to one embodiment then, vehicle data application 150 determines the payments to reach the ROA goals for each credit risk band/mileage band combination. For a credit risk band and mileage band, if the ROA determination for a term results in an ROA of less than the ROA hurdle for that term, the monthly payments (or start fee) can be increased until the ROA at that term is at least meets the ROA hurdle. This process can be repeated until the monthly payment schedule meets all of the ROA hurdles. The payment schedule that meets all the ROA hurdles for each credit risk band/mileage band combination may be stored in the inventory record for the VIN.

In addition or in the alternative, an “expected ROA” can be predicted for a given payment schedule. The expected ROA can be determined by multiplying the probability that a consumer will return a car in any given term by the predicted ROA for that term (for a vehicle, mileage band and credit risk band) and summing the results, e.g.,

$${ROA}_{expected} = {\sum }_{t = 1}^{final} ( {ROA}_{t} * {Prob}_{t} )$$

where final can be a configurable number to account for the fact, that at some point, the probability of returns occurring becomes insignificantly small.

The Probₜ represents the probability of a consumer returning a vehicle in a given month of the ownership agreement and may be based on a probability distribution that represents the probability that a consumer will return a vehicle in a given month. In one embodiment, for example, if it is believed that the mean hold time for vehicles will be 18 months and that returns will generally follow a Poisson distribution, automotive data processing system can determine Probₜ for each month according to a Poisson distribution. It can be noted that the Poisson distribution is provided by way of example and other distributions may be used. The probability distribution may be selected based on business rules or according to a model trained over returns data collected by automotive data processing system 100. As the system gains actual customer data on return timing, more accurate predictive models can be built concurrently to model projected vehicle return timing. A payment schedule may be determined so that the ROA_{expected} meets particular ROA hurdles.

At 1512, automotive data processing system 100 can update the inventory record with the base start fee(s) and monthly payments. For example, if there are 20 credit risk bands and 10 mileage bands defined, the automotive data processing system 100 can determine 20 adjusted base start fees (step 1506) and 200 monthly payment schedules (step 1508) and store the start fees and monthly payment schedules in the inventory record for the vehicle.

The base monthly payments may be adjusted to account for other factors. In some cases, the intermediary may add additional goods and services. For example, it may be desirable to include insurance, a maintenance contract or warranty with each vehicle. The prices for these products may be predetermined for a year/make/model/trim and mileage. Thus, in some embodiments, the data application may look up the cost of included add-ons (or request the cost from a third party information provider system 120) and add the cost of the required add-on (e.g., maintenance contract, warranty or other items) to the base monthly payment. Thus, the monthly payments stored in the inventory record may be adjusted to include payments for required add on products. In other embodiments, the base monthly payments and payments for the required add-ons are maintained separately, but combined before being surfaced to the user and for purposes of searching inventory that meets an affordability score.

Data processing system 100 may facilitate the purchase of inventory items. As such, data processing system 100 may maintain inventory records 136 for the inventory items. The inventory record 136 for an inventory item may hold a variety of information about an inventory item including one or more payment schedules for the inventory item. A payment schedule for an inventory item may include an initial payment amount and a periodic payment amount. In some cases, the payment schedule may include fees for add-ons.

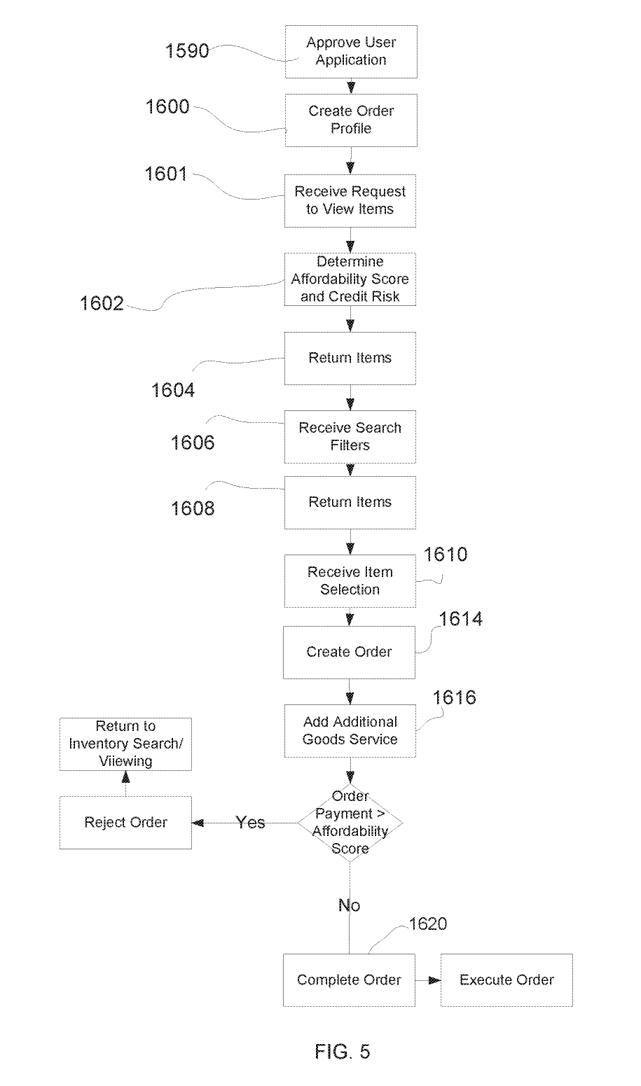

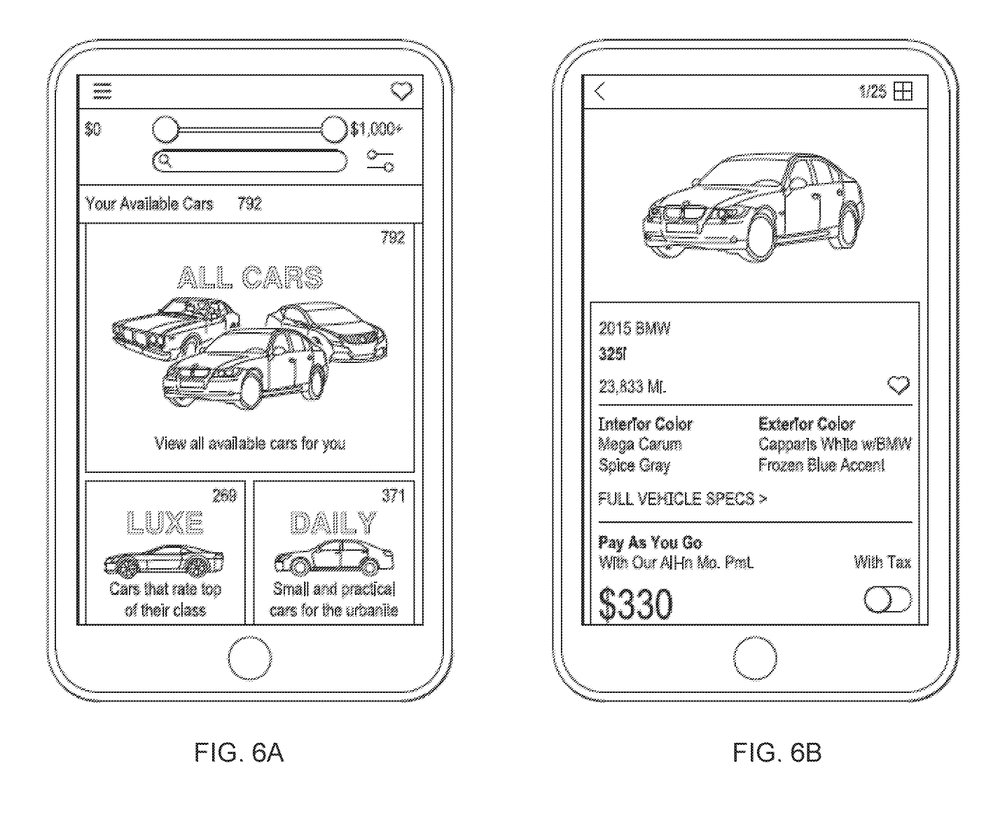

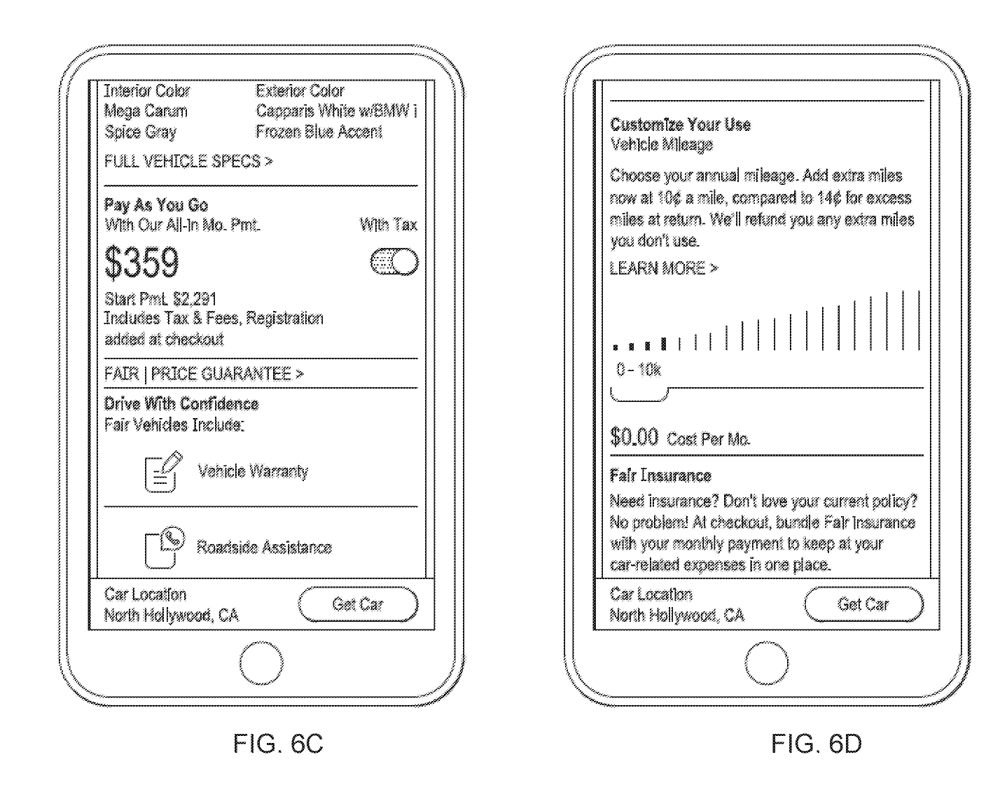

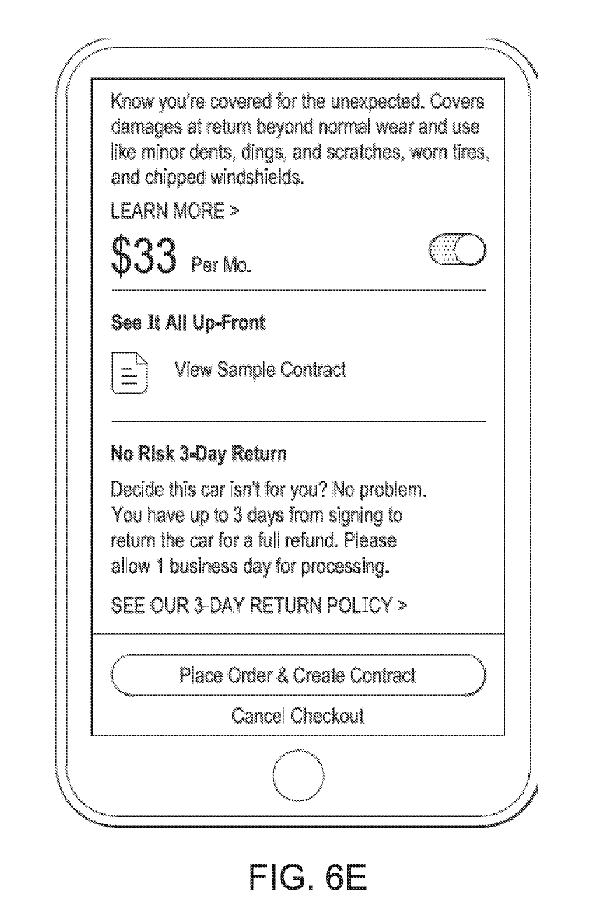

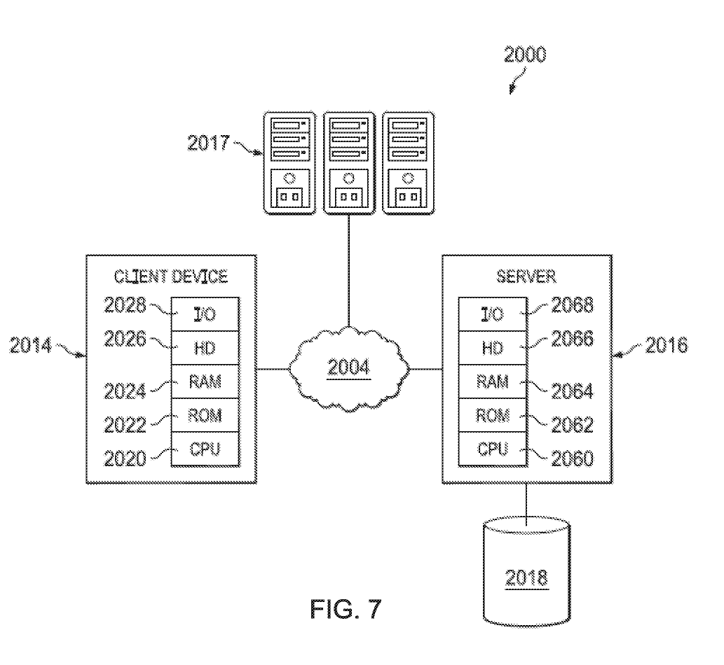

FIG. 5 is a flow chart of one embodiment of a purchase process that may be implemented by a data processing system, such as automotive data processing system 100. FIG. 6A, FIG. 6B, FIG. 6C, FIG. 6D, FIG. 6E illustrate one embodiment of a series of mobile application pages corresponding to a purchase process.

At 1590, a user application for financing can be approved and the user assigned an affordability score representing the periodic payment that an intermediary (financing provider) will approve for the consumer. The data processing system creates an order profile to track the purchase process after approval (step 1600). The order profile may include a variety of attributes, including encrypted PII, the consumer's affordability score and credit risk score and other information collected from the user, obtained from remote sources or generated by system 100. As a consumer browses inventory and selects inventory items, information from the inventory record and other information regarding the selected inventory item may be added to the order profile.

At step 1601, the data processing system can receive a request from a consumer to view inventory items (e.g., based on a user interaction in a GUI of client application 114). According to one embodiment, the inventory items comprise illiquid assets (or other assets that can act as collateral) (e.g., automobiles, boats, planes, real-estate, etc.). In some embodiments, an inventory item may comprise a combination of an illiquid asset and an item that cannot be used as security. For example, an inventory item may comprise a vehicle with an included maintenance contract.

The data processing system can search inventory items based on affordability score. The data processing system may also search its program pool for eligible inventory items based on other parameters, such as credit risk. Accordingly, the data processing system can determine the affordability score and other parameters associated with the consumer (step 1602). In some implementations, the affordability score may be included in the request from client application 114. In other embodiments, the affordability or credit risk score can be stored in a context maintained by a data application (e.g., vehicle data application 150). The data application uses the context data to augment the request.

At step 1604, the data processing system identifies a set of eligible inventory items for a consumer based on the consumer's affordability score, the periodic payment (e.g., monthly payment) for each inventory item and other factors, such as geography or other factors. In one embodiment, the data processing system identifies the eligible inventory items as those items having a monthly payment that is less than the consumer's affordability score. If the base monthly payment is not adjusted with the payments for the required add-on products in the inventory record, the inventory service may make this adjustment when searching for eligible inventory items. The data processing system can return inventory record information for the eligible inventory items. In the example of FIG. 6A, there are 792 available eligible vehicles for the consumer.

The consumer may provide consumer filter parameters to filter the set of eligible inventory items by various factors. The data processing system can receive the filter parameters (step 1606), search the inventory records of the eligible inventory items and return inventory record data for the inventory items meeting the filter criteria (step 1608). For example, if a consumer who has been approved for a payment of $1,062 a month indicates that he or she is searching for inventory meeting certain criteria, say made by a certain manufacturer, the data processing system can present to the consumer (e.g., through client application 114) inventory items made by the selected manufacturer that have a base monthly payment of $1062.

The inventory items presented may be filtered by the maximum approved monthly payment or the suggested approved monthly payment for the consumer. In another embodiment, the data processing system may apply a scaling factor such that the data processing system will present the consumer with inventory items that have a monthly payment<=maximum approved payment*scaling factor (e.g., $400*0.7). The scaling factor may be selected to help ensure that the consumer can afford additional products, such as maintenance contracts, and expected additional expenses (gas, insurance for vehicles). In any event, at this point, the consumer can view actual inventory items that fall within that individual's affordability as determined by the data processing system.

The consumer may select an inventory item from the set of eligible inventory items from the program pool (step 1610). In FIG. 17B, the consumer has selected a particular vehicle with a base monthly payment of $330. The monthly payment initially displayed to the user corresponds to the user's credit risk band and a default mileage band (e.g., 10,000 miles a year). Further, in the embodiment illustrated, the monthly payment includes a portion for an included insurance policy, maintenance policy and warranty.

The user may be provided with controls to adjust order payment parameters. As illustrated in FIG. 6C, the user can select to view the price with taxes. As another example, while the user may be shown a monthly payment based on a default mileage band, the user may be provided with controls to change the mileage band. For example, FIG. 6D illustrates an example in which the user is provided with a slider to adjust mileage band. It can be noted that, in some embodiments, the payment schedule for each mileage band may be provided to client application 114 when the user selects the particular vehicle. Thus, adjusting the slider of FIG. 6D may not require a call to the server.

The user may indicate a purchase decision—a decision to proceed with the purchase of an inventory item—such as by clicking “Get Car” (FIG. 6D) or other control in the GUI of client application 114. When a user indicates that he or she wishes to purchase an inventory item, all the information about the inventory item, including the initial payment and monthly payment should be known by the data processing system. The data processing system can create an “order” to capture the information about the transaction from the current context (e.g., the order profile or other containers of inventory item information, financing information, consumer information or other information) (step 1614). The order may be managed as an object.

The user may be given the opportunity to select additional items (goods or services) to add to the order (step 1616), including items that cannot act as security. In particular, the user may be presented with options for goods and services associated with the selected inventory item and that have recurring periodic payments. For example, the user may be presented with the option to add an extended warranty, maintenance contract or other item that has a monthly payment to the order. In the example of FIG. 6E, the user has selected to add a maintenance contract to the order. When the user selects to finalize a purchase, the data processing system can determine if the combined monthly (or other period) payments of the inventory item selected at step 1610 and other items in the order exceed the affordability score. If so, the data processing system can reject the order. Otherwise, the data processing system can proceed to an order completion process (step 1620) in which any remaining information necessary to complete the order is collected. The completion process may further include performing a hard pull credit check on the user. The completion process may further include generating any documents that require signature, receiving signed documents and taking other configured actions. At step 1622, the order is executed. For example, electronic financial transactions are initiated to transfer payments from the user to the seller, delivery of the ordered items is arranged or other actions taken.

Embodiments described herein not only overcome the deficiencies of prior computer systems, but also facilitate “micro-ownership.” With micro-ownership, the consumer may pay an initial, larger fee, and lower fixed monthly payments. Under an ownership agreement, the consumer may make monthly payments, but unlike with a lease, the consumer has the flexibility to return the vehicle when he or she no longer wishes to pay for the vehicle. Since a consumer can return the vehicle at any time, micro-ownership can eliminate default. And, unlike rental contracts that have terms typically limited to 30 days, the ownership agreement does not have to be renewed continually.

The computer system facilitates this type of ownership through the application of rules/models to inventory items to select inventory items that are priced close to their wholesale values at the start of the agreement and determine payments for the inventory items that meet particular metrics (e.g., an ROA hurdle or other metric) so that the ownership agreement can be viable for an intermediary providing financing without requiring a fixed term.

The payments for a vehicle may be based on residual value models which incorporate assumptions regarding miles per year and vehicle condition. As such, the ownership agreement may require the consumer to maintain the vehicle, maintain insurance on the vehicle or take other actions so that the vehicle should not depreciate more rapidly than predicted when the initial and monthly payments were determined. The consumer may also have the option of purchasing additional miles-per-year at the time of sale. Within certain limits, though, the consumer may return a purchased vehicle without further obligation.

In any event, the ownership agreement may provide for additional payments at vehicle return if the vehicle is returned with excessive mileage, excessive wear and tear, evidence of accidents, etc. Therefore, further obligations may exist when the consumer returns the vehicle if the vehicle has excessive mileage or wear and tear or exhibits evidence of an accident.

According to some embodiments, the vehicle initial payment and monthly payment (plus mileage allowance) are selected to allow the consumer to return the vehicle at any time, within limits and with sufficient notice, without further obligation. The ownership agreement may include terms, for example, that require minimum maintenance and repairs, etc. such that owner may have some remaining obligation if the vehicle is returned in poor condition.

FIG. 8 depicts a diagrammatic representation of a distributed network computing environment where embodiments disclosed can be implemented. In the example illustrated, network computing environment 2000 includes network 2004 that can be bi-directionally coupled to a client computing device 2014, a server system 2016 and one or more third party system 2017. Server system 2016 can be bi-directionally coupled to data store 2018. Network 2004 may represent a combination of wired and wireless networks that network computing environment 2000 may utilize for various types of network communications known to those skilled in the art.

For the purpose of illustration, a single system is shown for each of client computing device 2014 and server system 2016. However, a plurality of computers may be interconnected to each other over network 2004. For example, a plurality client computing devices 2014 and server systems 2016 may be coupled to network 2004.

Client computer device 2014 can include central processing unit (“CPU”) 2020, read-only memory (“ROM”) 2022, random access memory (“RAM”) 2024, hard drive (“HD”) or storage memory 2026, and input/output device(s) (“I/O”) 2028. I/O 2028 can include a keyboard, monitor, printer, electronic pointing device (e.g., mouse, trackball, stylus, etc.), or the like. In one embodiment I/O 2028 comprises a touch screen interface and a virtual keyboard. Client computer device 2014 may implement software instructions to provide a client application configured to communicate with an automotive data processing system. Likewise, server system 2016 may include CPU 2060, ROM 2062, RAM 2064, HD 2066, and I/O 2068. Server system 2016 may implement software instructions to implement a variety of services for an automotive data processing system. These services may utilize data stored in data store 2018 and obtain data from third party systems 2017. Many other alternative configurations are possible and known to skilled artisans.

Each of the computers in FIG. 8 may have more than one CPU, ROM, RAM, HD, I/O, or other hardware components. For the sake of brevity, each computer is illustrated as having one of each of the hardware components, even if more than one is used. Each of computers 2014 and 2016 is an example of a data processing system. ROM 2022 and 2062; RAM 2024 and 2064; HD 2026, and 2066; and data store 2018 can include media that can be read by CPU 2020 or 2060. Therefore, these types of memories include non-transitory computer-readable storage media. These memories may be internal or external to computers 2014 or 2016.

Portions of the methods described herein may be implemented in suitable software code that may reside within ROM 2022 or 2062; RAM 2024 or 2064; or HD 2026 or 2066. The instructions may be stored as software code elements on a data storage array, magnetic tape, floppy diskette, optical storage device, or other appropriate data processing system readable medium or storage device.

While the foregoing embodiments were provided primarily in the context of an automotive data processing system, it will be appreciated that embodiments described herein may be applied to other assets (e.g., real-estate, boats, etc.). In particular, embodiments may be adapted for assets for which depreciation can be modeled. Moreover, those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

To the extent particular values are provided in any example embodiments in the description, such values are provided by way of example and not limitation. Moreover, while in some embodiments rules may use hardcoded values, in other embodiments rules may use flexible values. In one embodiment, one or more of the values may be specified in a registry, allowing the value(s) to be easily updated without changing the code. The values can be changed, for example, in response to analyzing system performance.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A rules-based data processing system comprising:
a data store storing a set of depreciation models each depreciation model having an associated vehicle year/make/model/trim and payment rules to determine payment schedules for vehicles using the set of depreciation curves;
a processor and a memory coupled to the processor storing a set of computer executable instructions, the set of computer executable instructions executable to:
receive a first set of inventory feed records, each inventory feed record in the first set of inventory feed records comprising a vehicle identification number (VIN), dealer price and mileage;
apply a first set of filter rules to the first set of inventory feed records to identify a second set of inventory feed records corresponding to vehicles having year/make/model/trim for which a depreciation curve is stored in the data store, wherein filtering the first set of inventory records to identify the second set of inventory feed records comprises:
for each vehicle in the first set of inventory feed records:
determine if there is a corresponding depreciation curve for the year/make/model/trim of the vehicle in the set of depreciation curves;
based on a determination that there is not a corresponding depreciation curve for the year/make/model/trim of the vehicle in the set of depreciation curves, filtering out the inventory feed record for that vehicle;
based on a determination that there is the corresponding depreciation curve for the year/make/model/trim of the vehicle in the set of depreciation curves, include the inventory feed record for that vehicle in the second set of inventory feed records;
for each vehicle in a program pool that comprises vehicles from the second set of inventory records, apply the payment rules using the depreciation curve corresponding to the year/make/model/trim of the vehicle to determine a payment schedule for one or more vehicles in the second set of inventory records and storing the payment schedule for the vehicle in an inventory record for that vehicle.

2. The rules-based data processing system of claim 1, wherein the first set of filter rules comprises an age filter to filter out vehicles based on model years.

3. The rules-based data processing system of claim 1, wherein the first set of filter rules comprises a mileage filter to filter out vehicles based on mileage.

4. The rules-based data processing system of claim 1, wherein the set of computer executable instructions are further executable to: for each vehicle in the second set of inventory feed records, enhance an inventory record with data from remote information provider systems.

5. The rules-based data processing system of claim 4, wherein the set of computer executable instructions are further executable to apply a second set of filter rules to the second set of inventory records.

6. The rules-based data processing system of claim 5, wherein the data from the remote information provider systems comprises a wholesale value and the second set of filter rules comprises a filter rule to filter out vehicles having an associated dealer price that is not within a specified range of the wholesale value.

7. The rules-based data processing system of claim 5, wherein the set of computer executable instructions are further executable to:
for each vehicle in the program pool:
determine a current value of the vehicle;
determine a residual value of the vehicle at each of a plurality of terms by applying the corresponding depreciation curve to the current value;
calculate a payment schedule for the vehicle based on the residual values of the vehicle and a unit economics model;
store the payment schedule as a pre-calculated payment schedule for the vehicle in the inventory record for the vehicle.

8. The rules-based data processing system of claim 7, wherein calculating the payment schedule for a vehicle comprises calculating the payment schedule for each of a plurality of mileage bands.

9. The rules-based data processing system of claim 7, wherein calculating the payment schedule for each of a plurality of mileage bands comprises calculating the payment schedule so that a plurality of ROA hurdles are met.

10. The rules-based data processing system of claim 1, further comprising:
a machine learning regression model having independent variables representing features of vehicles and having a dependent variable that indicates an expected value of a vehicle, wherein the set of computer executable instructions are executable to use the regression model to determine the depreciation curves.

11. The rules-based data processing system of claim 1, wherein the set of computer executable instructions are further executable to publish inventory records corresponding to the program pool, the published inventory records retrievable based on payment schedule.

12. A computer program product comprising a non-transitory computer readable medium storing a set of computer executable instructions, the set of computer executable instructions executable to:
receive a first set of inventory feed records, each inventory feed record in the first set of inventory feed records comprising a vehicle identification number (VIN), dealer price and mileage;
apply a first set of filter rules to the first set of inventory feed records to identify a second set of inventory feed records corresponding to vehicles having year/make/model/trim for which a depreciation curve is stored in the data store, wherein filtering the first set of inventory records to identify the second set of inventory feed records comprises:
for each vehicle in the first set of inventory feed records:
determine if there is a corresponding depreciation curve for the year/make/model/trim of the vehicle in a set of depreciation curves stored in a data store;
based on a determination that there is not a corresponding depreciation curve for the year/make/model/trim of the vehicle in the set of depreciation curves, filtering out the inventory feed record for that vehicle;
based on a determination that there is the corresponding depreciation curve for the year/make/model/trim of the vehicle in the set of depreciation curves, include the inventory feed record for that vehicle in the second set of inventory feed records;
for each vehicle in a program pool that comprises vehicles from the second set of inventory feed records, apply payment rules using the depreciation curve corresponding to the year/make/model/trim of the vehicle to determine a payment schedule for the vehicle and storing the payment schedule for the vehicle in an inventory record for the vehicle.

13. The computer program product of claim 12, wherein the first set of filtering rules comprises an age filter to filter out vehicles based on model years.

14. The computer program product of claim 12, wherein the first set of filter rules comprises a mileage filter to filter out vehicles based on mileage.

15. The computer program product of claim 12, wherein the set of computer executable instructions are further executable to: for each vehicle in the second set of inventory feed records, enhance an inventory record with data from remote information provider systems.

16. The computer program product of claim 15, wherein the set of computer executable instructions are further executable to apply a second set of filter rules to the inventory records.

17. The computer program product of claim 16, wherein the data from the remote information provider systems comprises a wholesale value and the second set of filter rules comprises a filter rule to filter out vehicles having an associated dealer price that is not within a specified range of the wholesale value.

18. The computer program product of claim 12, wherein the set of computer executable instructions are further executable to:
for each vehicle in the second set of inventory feed records:
determine a current value of the vehicle;
determine a residual value of the vehicle at each of a plurality of terms by applying the corresponding depreciation curve to the current value;
calculate a payment schedule for the vehicle based on the residual values of the vehicle and a unit economics model;
store the payment schedule as a pre-calculated payment schedule for the vehicle in the inventory record for the vehicle.

19. The computer program product of claim 12, wherein calculating the payment schedule for a vehicle comprises calculating the payment schedule for each of a plurality of mileage bands.

20. The computer program product of claim 12, wherein calculating the payment schedule for each of a plurality of mileage bands comprises calculating the payment schedule so that a plurality of ROA hurdles are met.

21. The computer program product of claim 12, further comprising:
a machine learning regression model having independent variables representing features of vehicles and having a dependent variable that indicates an expected value of a vehicle, wherein the set of computer executable instructions are executable to use the regression model to determine the depreciation curves.

22. The computer program product of claim 12, wherein the set of computer executable instructions are further executable to publish inventory records corresponding to the program pool, the published inventory records retrievable based on payment schedule.
